(19) United States
(12) Patent Application Publication
(10) Pub. No.: US 2006/0225980 A1
(43) Pub. Date: Oct. 12, 2006

(54) Tunable adjustable multi-element hybrid particle damper

(76) Inventors: Stepan S. Simonian, Torrance, CA (US); Sarah M. Brennan, Manhattan Beach, CA (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/375,716

(22) Filed: Mar. 15, 2006

Related U.S. Application Data
(60) Provisional application No. 60/670,003, filed on Apr. 11, 2005.

(51) Int. Cl. F16F 7/10

(52) U.S. Cl. 188/380

(57) ABSTRACT

Apparatus, and a related method, for damping vibrations in a flexible structure by a combination of tuned mass damping and particle damping. Combining the two damping techniques in a single apparatus provides a desirable frequency response characteristic that provides damping over a wide frequency range and, because the apparatus is relatively insensitive to temperature changes, provides reliable damping in space structures exposed to extremes of temperature. Damping with the apparatus can be tuned and adjusted by selection of appropriate components for the tuned mass damping portion and, in the particle damper portion, by selection of a tuning beam length, the size and material of particles, and a particle container gap height.

### CROSS-REFERENCE TO RELATED APPLICATION

This application claims, under 35 U.S.C. §119(e), the filing priority of Provisional Application No. 60/670,003, filed Apr. 11, 2005, and having the same title as the present invention.

### BACKGROUND

This invention relates generally to suppression of vibration in mechanical structures and, more particularly, to passive techniques for damping large amplitude vibrations in flexible structures over a broad frequency range and over a wide range of temperatures. The ability to damp mechanical vibrations in structures is critical in a variety of applications, including vehicles such as spacecraft, aircraft or automobiles, as well as in other structures exposed to vibratory forces.

One common technique for passively damping vibrations is known as tuned mass damping, in which additional mechanical components with spring, mass and damper elements are added to the structure subject to vibration. The additional components are “tuned.” i.e., selected to provide a vibration damping effect over a desired frequency range, which is inherently quite narrow. Often a damper is designed to target a specific resonant frequency of a component because this resonance coincides with a disturbance input. A tuned mass damper (TMD) is a damper that targets the response of a system at a specific frequency, and the spring, mass, and damper elements of the TMD are tuned to be most effective at this frequency.

Another known technique for vibration damping is to employ a particle damper. Particle dampers are passive devices that are characterized by a system of particles that rattle within a container that is affixed to a vibrating structure. The particles interact with each other and the container to dissipate energy through friction and elastic/plastic deformation and momentum exchange. They are inexpensive, versatile, and robust, and they have been used effectively to reduce the vibration levels of sensitive hardware across a broad range of industries. Particle dampers are particularly desirable in some applications because they are insensitive to temperature and demonstrate significant damping over a wide frequency band given sufficient excitation amplitudes.

For more complex systems with high modal densities (i.e. with vibration over a substantial range of frequencies), the TMD is a far from perfect solution, since it offers little attenuation at frequencies outside a narrow band centered on the target frequency. Moreover, particle damping does not effectively target vibration at particular frequencies. Accordingly there is a need for vibration damping technique that addresses these problems.

### SUMMARY

The invention in one implementation encompasses an apparatus for attenuating vibration in a flexible structure. The apparatus comprises a tuned mass damping element, coupled to the flexible structure and having parameters selected to attenuate vibration over a desired frequency range. The apparatus comprises a particle mass damping element coupled to the tuned mass damping element and having parameters selected to attenuate vibration over a desired broad range of frequencies. The combined effect of the tuned mass damping element and the particle mass damping element is to increase the frequency range of vibration attenuation of the tuned mass damping element.

The present invention resides in a vibration damping technique that effectively combines the advantages of the tunable mass damper (TMD) and the particle damper. The invention embodies a novel vibration suppression concept because of its ability to be adapted for both customizing the necessary frequency response and for varying levels of vibration energy absorption. The inventive concept of a multi-element hybrid damper is to simultaneously combine both tuned mass dampers and particle dampers, for use in many applications, including space vehicles, aircraft, and automotive/ground transport vehicles, as well as more generally in other mechanical structures subject to vibration

The concept of the tunable adjustable hybrid particle damper merges two existing technologies: the tuned mass damper, a device which is highly effective at attenuating disturbances at a narrow frequency band, and the particle damper, a versatile and robust damping technique that is less sensitive to frequency. In practice the device of the invention comprises a flexible member to which a particle damper is attached (e.g., an adjustable length cantilever beam to the end of which a particle filled container is attached securely). This structure is then affixed to a stiff, vibrating member. The damper cavity may assume any geometry, and is partially filled with particles. The size and material selection of the particle elements will depend on the application. For tuning purposes, the distance from the top surface of the particle bed to the top of the enclosure may also be adjustable. The energy dissipation of this device is dominated by the interaction of the particles with each other and with the walls of the container that is characterized by friction and elastic/plastic deformation. The response of this hybrid system is distinctive when compared to either particle dampers or tuned mass dampers and has been demonstrated through testing. Furthermore, the hybrid concept can include multiple tuned mass dampers, and/or multiple axis particle dampers for further spectral customization in specific applications.

It will be appreciated from the foregoing that the present invention represents a significant advance in the field of vibration attenuation. In particular, the combination of tuned mass damping and particle damping achieves desirable damping characteristics not previously obtainable using either of these techniques alone. Other aspects and advantages of the invention will become apparent from the detailed description of the invention, taken in conjunction with the accompanying drawings.

### BRIEF DESRIPTION OF THE DRAWINGS

FIG. 1 is a model representation of a tuned mass damper of the prior art.

FIG. 2 is a diagram showing the principal elements of an undamped vibrating structure under test.

FIG. 3 is a diagram showing the principal elements of a particle tuned mass damper (PTMD) under test in accordance with the present invention.

FIG. 4 is a diagram showing the principal elements of a conventional particle damper under test.

FIG. 5 is a graph of the frequency response of an undamped structure.

FIG. 6 is a set of graphs of the frequency response of a particle damper, measured at various gap heights in a particle container of the damper.

FIG. 7 is a set of graphs of the frequency response of a particle tuned mass damper (PTMD) in accordance with the invention, with the measurements for each graph being taken for a different tuning beam length.

FIG. 8 is a set of graphs of the frequency response of a PTMD, with the measurements for each graph being taken for a different particle container gap height.

FIG. 9 is a set of graphs of the frequency response of a PTMD using lead particles and two different gap heights.

FIG. 10 is a set of graphs of the frequency response of a PTMD using tungsten particles and several different gap heights.

FIG. 11 is a set of graphs of the frequency response of a PTMD using steel particles and several different gap heights.

FIG. 12 is a set of graphs of the frequency response of a TMD, with the measurements for each graph being taken with a different tuning parameter affecting the degree of damping.

FIG. 13 is a graph of the frequency response of a PTMD, showing damping over a wider frequency range than for the TMD, and showing insensitivity to the degree of damping employed.

FIG. 14 is a pair of graphs showing the average power dissipation of a particle damper as it varies with cylinder gap height, wherein the lower curve plots test results and the upper curve plots simulated results.

### DETAILED DESCRIPTION OF THE INVENTION

As shown in the accompanying drawings, the present invention is concerned with techniques for damping vibration in mechanical structures. The known concept of tuned mass damping (TMD) is effective, but only over a relatively narrow frequency range. Another known concept, particle damping, provides vibration attenuation over a wider frequency range but does not necessarily target vibration at particular frequencies.

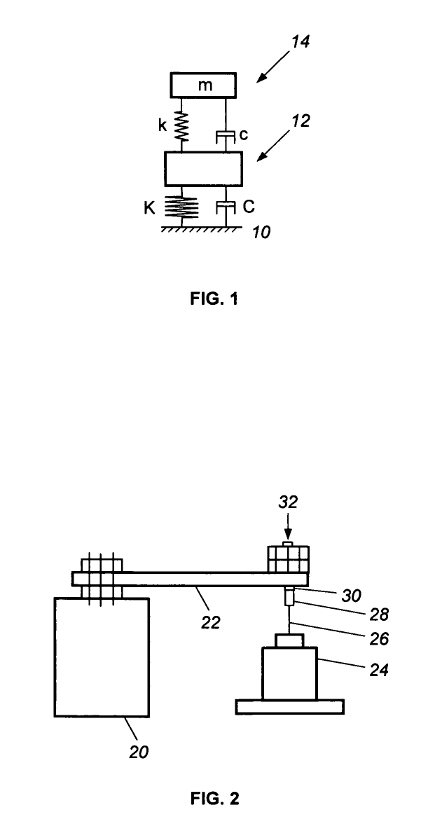

In accordance with the invention, a hybrid damping technique, referred to as a particle tuned mass damper (PTMD) achieves vibration damping over a desired range of frequencies and functions more effectively than either TMD or particle damping alone. By way of introduction, FIG. 1 depicts the elements of a model tuned mass damper (TMD). The hatched line 10 at the bottom of the figure represents a stationary frame of reference, such as the ground (in the case of a terrestrial structure) or a large inertial mass (in the case of a spacecraft or other vehicle). The structural component subject to vibration, indicated generally by reference numeral 12, may be characterized by a mass M, a spring constant K, and a damper parameter C. In tuned mass damping, an additional structure 14 having a mass m, spring constant k and damper parameter c, is coupled to the component 12 subject to vibration and is tuned, by adjusting the constants m, k and c, to achieve damping at a desired narrow frequency range.

In FIG. 2, an undamped system is represented in a testing configuration by an inertial mass 20 and a primary beam 22 to which a vibratory force is applied by a shaker 24, through an actuator rod 26 and flexure 28 positioned to apply vibration along a single axis to the primary beam 22. For purposes of testing, the arrangement also includes a force transducer 30 for measuring the applied vibration force and an accelerometer 32 attached to the primary beam 22, by means of which vibration is measured as an acceleration value. In essence, the primary beam of FIG. 2 is characterized by the values M, K and C of FIG. 1.

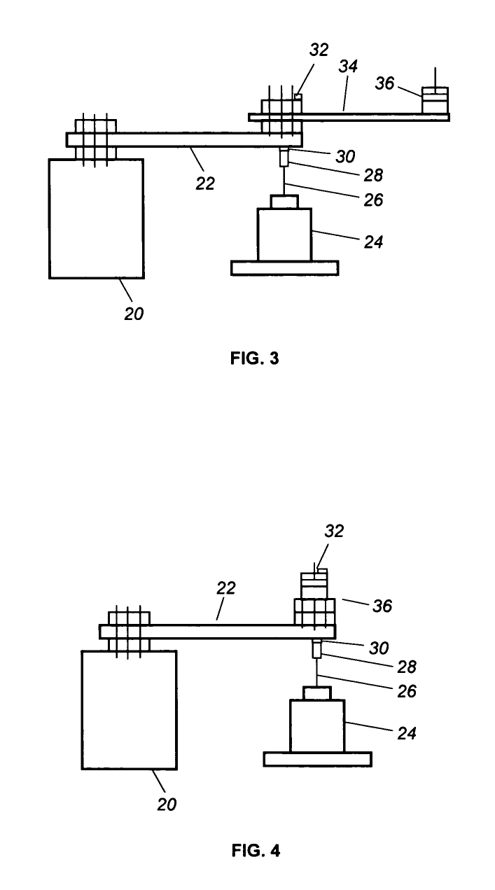

In FIG. 3, which depicts an apparatus embodying the principles of the present invention, a tuning beam 34 is rigidly attached to the primary beam 22 and a particle damper 36 is affixed to the end of the tuning beam. The accelerometer 32 is located at the tip of the primary beam 22. The tuning beam 34 and particle damper 36 may be characterized as having a mass m′, a spring constant k′ and a damper parameter c′.

FIG. 4 depicts by way of comparison a traditional particle damper configuration, in which the particle damper 36 is positioned at the end of the primary beam 22, to act as the primary damping means applied to the vibrating beam 22.

As in the traditional particle damping configuration of FIG. 4, the particle damper as used in the invention shown in FIG. 3 comprises a particle container that is only partially filled with particles. In other words the particle bed in the container has a variable gap above the natural level of the particles within the container. In the apparatus of the present invention, this gap is variable, both in the sense that it may change during operation as the particles rattle in the container, and also in the sense that the gap dimension is one of the parameters of the particle damper that can be adjusted to achieve desired particle damping characteristics. In some applications, the gap dimension may be adjusted dynamically after the damper has been deployed. For a configuration in which a cylindrical container has its longitudinal axis aligned with gravity and with the direction of the vibration force, the bed of particles remains essentially level.

In addition to the gap dimension (or container volume as it affects the gap dimension), other parameters that can be adjusted and selections that can be made for tuning purposes include the length of the tuning beam 34, and the particle type (size and material). Most of the remaining drawing figures depict the frequency response of the apparatus of the invention in contrast to the frequency response when using TMD or particle damping alone.

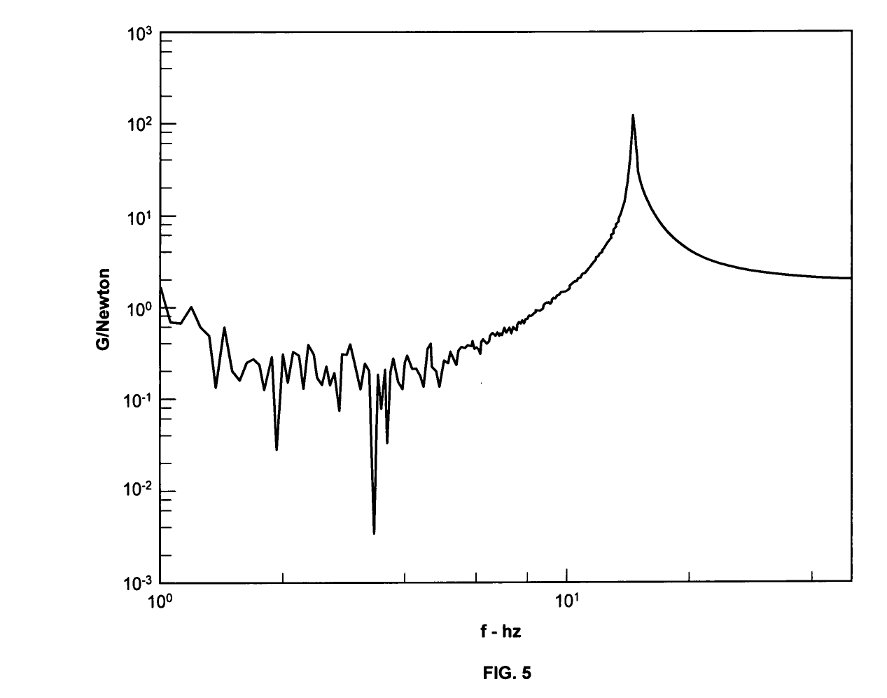

The single curve in FIG. 5 is the frequency response of the undamped system, i.e., the response of the primary beam 22 (FIG. 2) without damping of any kind. In the configuration of FIG. 2, the beam 22 is subject to vibration over a range of frequencies from 1 Hz to 50 Hz. The response is measured in terms of a transfer function between the input signal provided by the force transducer 30 and the output response measured by the accelerometer 32. Thus, the units plotted along the vertical axis of FIG. 5 and in other similar graphs to be discussed, is acceleration per unit input force. The horizontal axis plots frequency, and both axes use a logarithmic scale. It will be observed from this example that the undamped response exhibits a fundamental resonance peak at approximately 14.6 Hz.

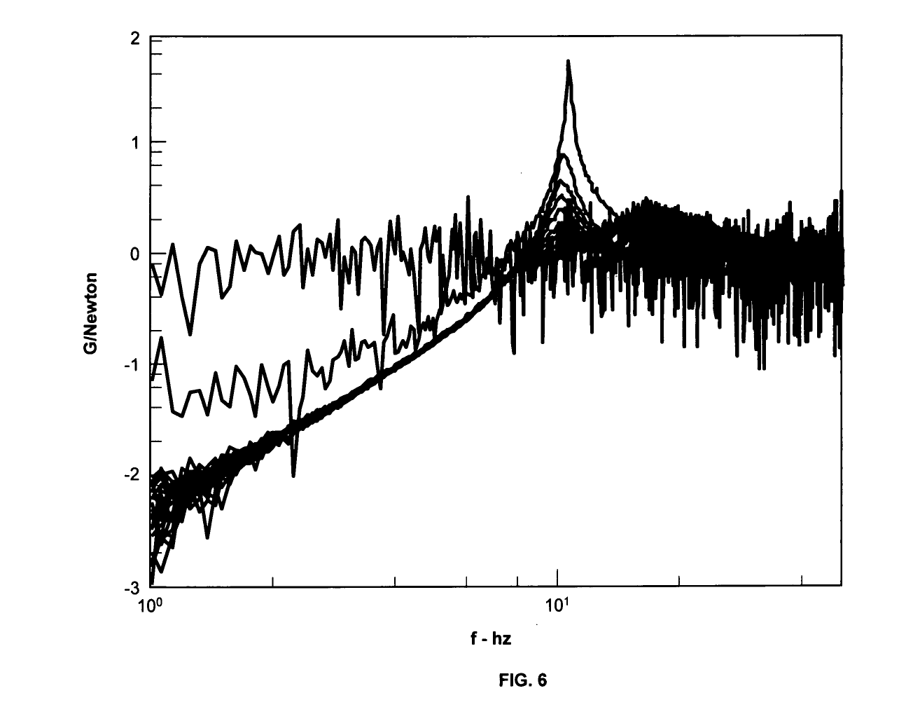

FIG. 6 shows the frequency response of a traditional particle damper configuration, like the one in FIG. 4, where a particle damper 36 is mounted at the end of the primary beam 22. The multiple curves in FIG. 6 were derived from measurements taken using different gap heights above the particle in the damper 36. The graphs show, at least qualitatively, that the traditional particle damping approach is sensitive to the gap height.

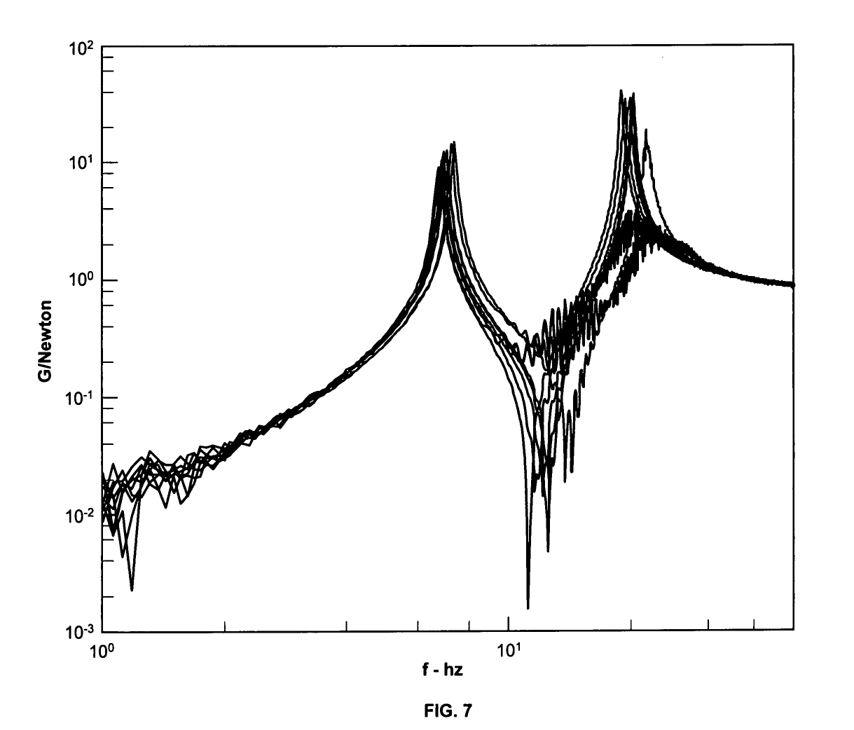

FIG. 7 depicts the frequency response for the particle tuned mass damper (PTMD) of the invention, as illustrated in FIG. 3. The multiple curves shown are derived from measurements made using a range of different lengths of the tuning beam 34, over a range from 8.5 inches (21.6 cm) to 11 inches (27.9 cm). It will be observed that all of the frequency responses exhibit a double-peaked characteristic and that the tuning beam length has little effect on the frequencies of the two peaks, at approximately 7 Hz and 11 Hz, respectively. The principal effect of varying the tuning beam length is that shorter beam lengths result in a lower amplitude for the peak centered at about 11 Hz. In the configuration of FIG. 3, the curves of FIG. 7 were used to select a tuning beam length that provided the most symmetrical amplitude distribution of the two peaks.

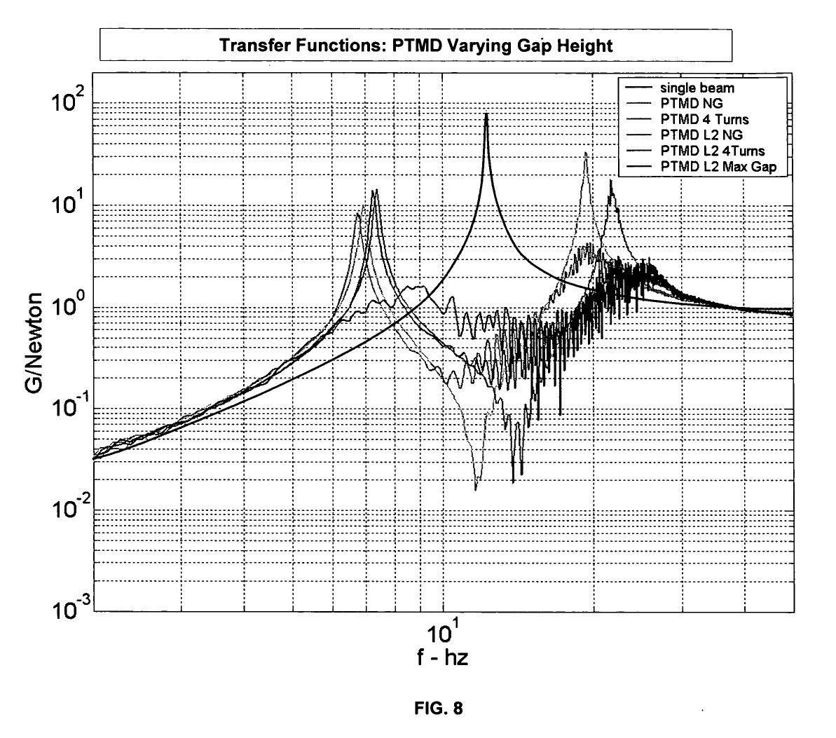

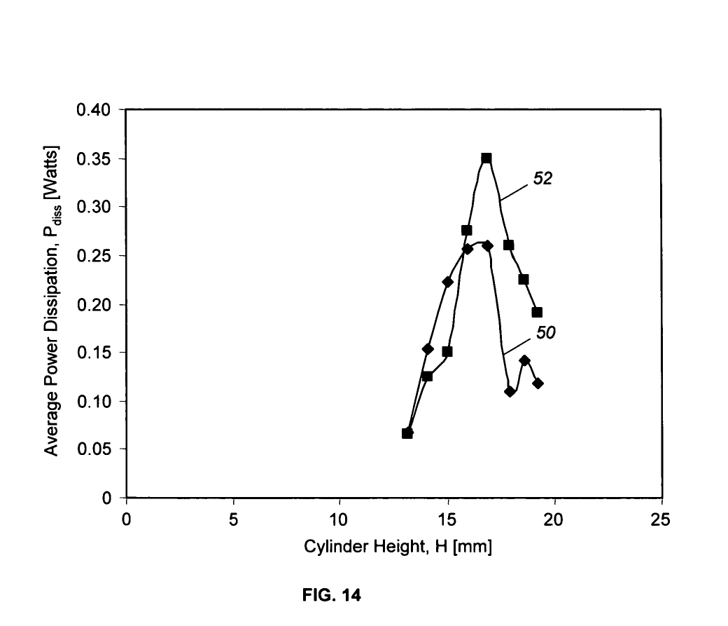

FIG. 8 depicts the effect of the particle gap height on the frequency response of the FIG. 3 apparatus. The single-peaked curve is the frequency response obtained when only a single beam (22) is used and the particle damper is located at the end of this beam. All the other curves result from observations of the FIG. 3 apparatus for various gap heights. It is clear from the these curves that an optimal gap distance exists that offers the greatest damping of the resonance node. It is also clear that the gap distance has a significant effect on the PTMD response. The nature of this effect is explored in another figure (FIG. 14).

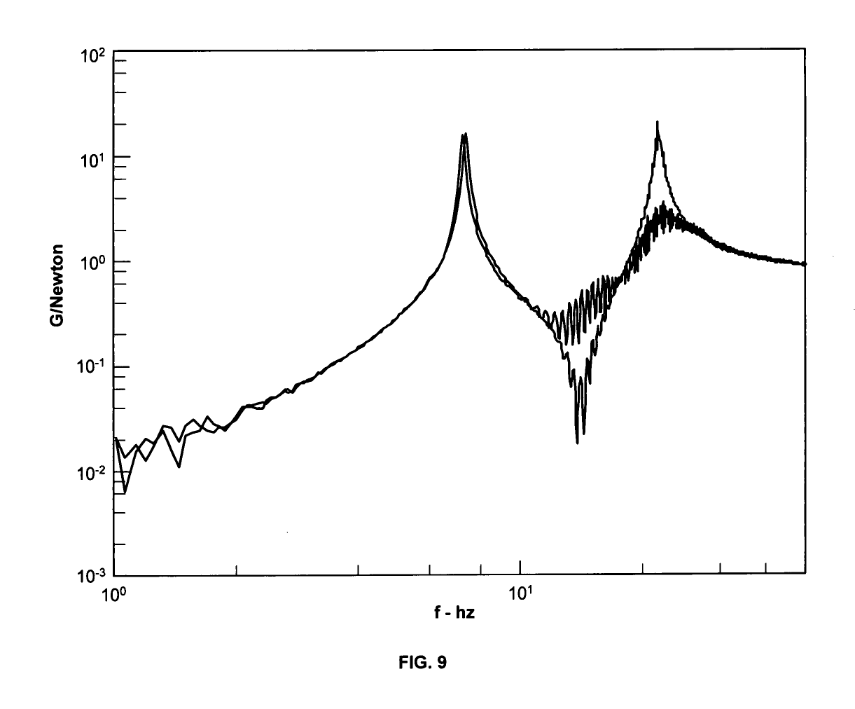

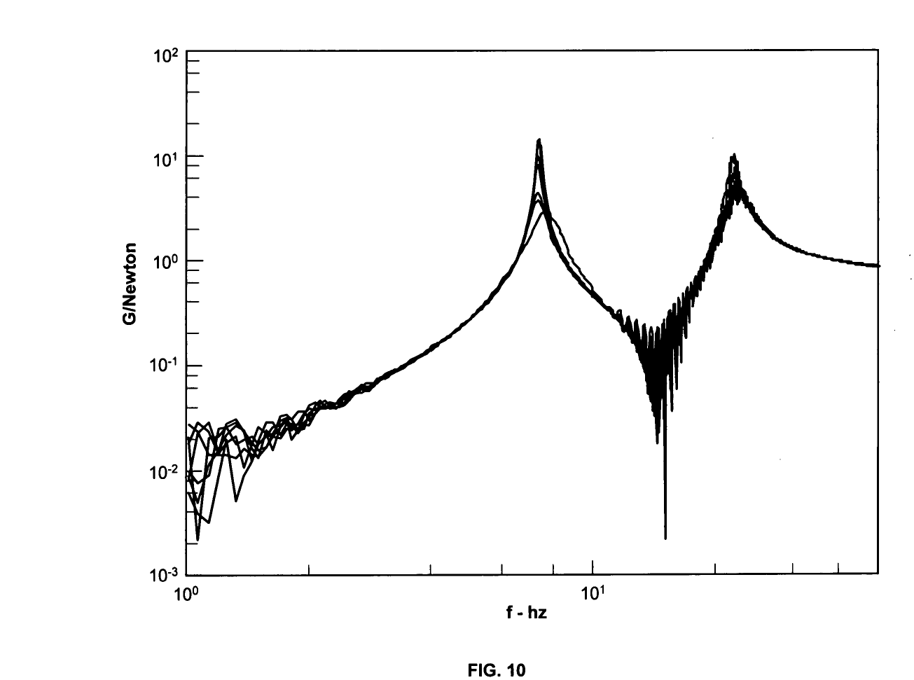

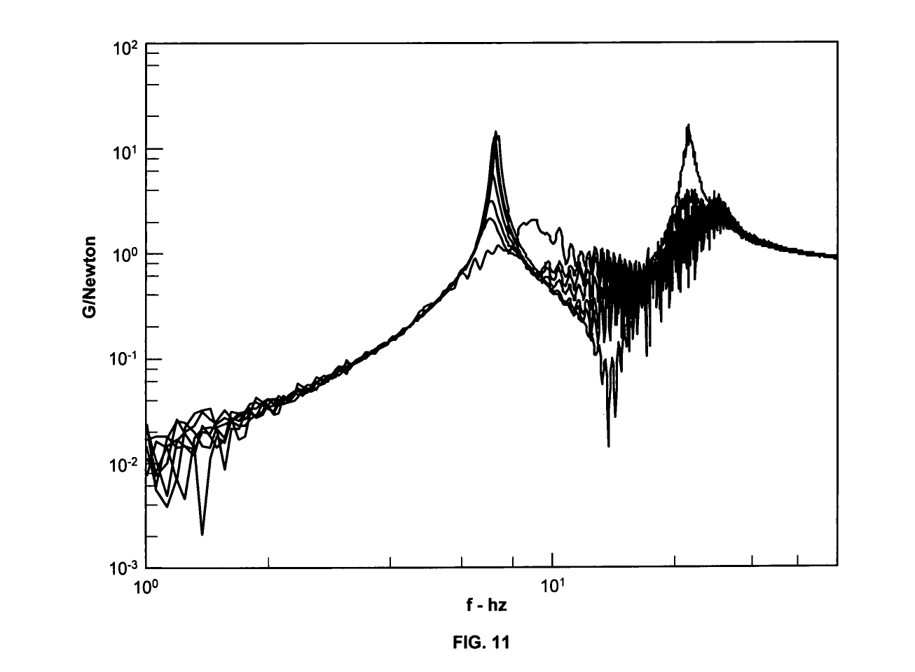

FIG. 9 illustrates the frequency response of the PTMD when lead particles are used, for two different gap heights. FIG. 10 shows the frequency response of the PTMD using tungsten particles and a range of gap heights. FIG. 11 shows the frequency response of the PTMD using steel particles (ball bearings), over a range of gap heights. Similar results were obtained using copper particles, and various mixtures of steel and lead particles, such as 50% steel and 50% lead particles, and 30% steel and 70% lead particles, measured by mass. All of these selections provided double-peaked response curves, with the peak amplitudes and frequencies being remarkably similar in all cases. From these results, it appears that variation in gap height has a greater effect on the frequency response than the selection of particle material.

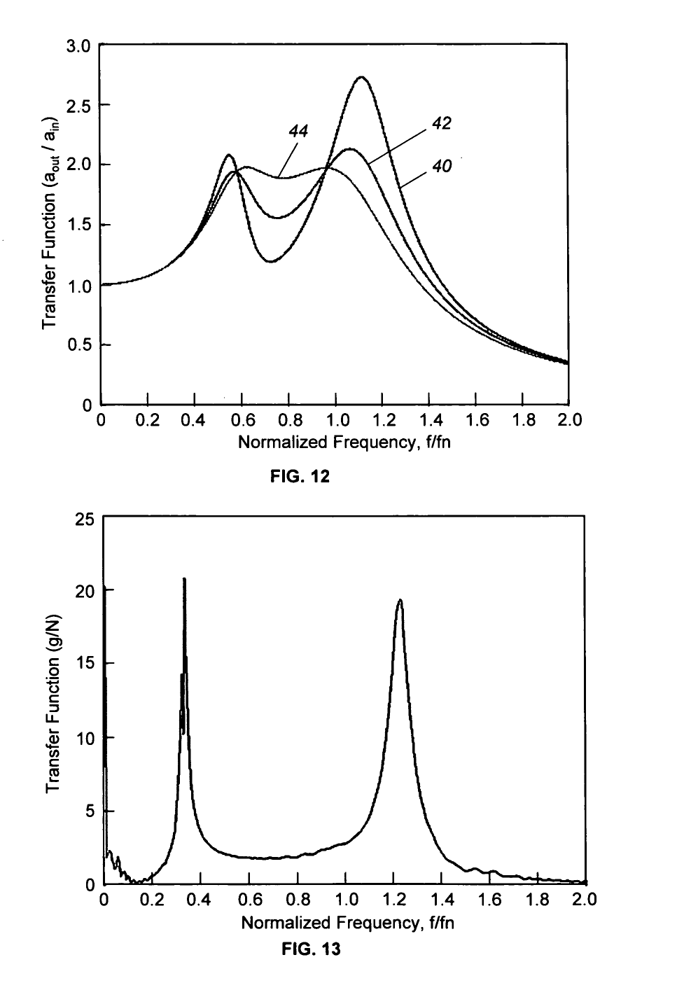

FIG. 12 shows how the transmissibility of a conventional TMD can be optimized by varying a tuning parameter and thereby changing the degree of damping. The three curves plot the variation of response with normalized frequency, for three different damping factors. In curve 40, with the least damping, the two peaks in the response are spaced further apart than in curves 42 and 44, which are plotted for increased damping effects. In curve 44, with the increased damping the system approaches an optimal performance condition in which the response peaks are equal in amplitude. However, the frequency span over which damping is effective is decreased because the peaks are closer together in frequency (0.623 and 0.968 normalized frequency values).

By way of contrast, FIG. 13 shows a typical frequency response for the PTMD of the invention. Not only are the peaks more widely spaced (0.33 and 1.212 normalized frequency values), but the response characteristic is not sensitive to the PTMD damping value.

One measure of the damping effectiveness of a particle impact damper is the power dissipated in the damper. Although direct measurement of the dissipated power is an elusive goal, it is possible to compute the dissipated power from direct measurements of the force applied to the damper and the velocity attained by the damper. In brief, if the force is F and the velocity is V, the dissipated power is the imaginary component of the complex product: P=FV*, where the asterisk denotes a complex conjugate. When the dissipated power is measured in this manner for various amplitudes of oscillation, it was found that the dissipated power (and hence the damping effect) varies linearly with the amplitude. Moreover, if dissipated power is measured for different cylinder heights (gap distances above the particle bed), it is possible to identify a gap distance that results in maximum damping effect. This is shown graphically in FIG. 14, where both the measured dissipated power (curve 50) and simulated measurement of dissipated power (curve 52) indicate a distinct peak in dissipated power for a gap distance of about 16 to 17 mm.

From the foregoing it will be understood that, for a particular application and damper configuration, it is possible to select optimum parameters for gap distance, tuning beam dimensions, and particle material and size. The optimization can be based on test measurements or computer simulations, or both. It will also be understood from the foregoing that the PTMD apparatus of the invention has a wider frequency range between two response peaks, as compared with a TMD system having the same tuning mass ratio.

The invention as described above represents a significant advance in techniques for damping vibrations of flexible structures. In particular, the invention provides damping of large amplitude vibrations over a broad frequency range and over a wide range of temperatures. Particle dampers have been demonstrated in a variety of applications, including spacecraft launch survivability and automobile applications. Tuned mass dampers are also widely used and their behavior is predictable from available models. The combination of both forms of damping in a single hybrid device provides an effective and low cost solution that is highly suited for space applications. Although the invention has been demonstrated only in terrestrial (1-g) conditions, indications from research relating to particle dampers are that damping effectiveness of the invention may actually improve in zero-gravity conditions.

While the description of the invention focuses primarily on the concept of a passive device, the potential exists to activate this vibration absorber by adding an active element (such as a motor, piezoelectric ceramic material, electro-active polymer, etc.) to vary the height of the container for applications that might require time-varying damping levels.

Further, it will be understood that the particle damper element of the invention may be implemented in various ways, and that the particle container may be mounted on a vibrating structure using various types of springs that contribute to the tunable spring constant of the apparatus. For example, the particle container may be attached to a frame using diaphragm springs, or springs of generally conical shape (known as Belleville springs), or by solid materials with elastomeric properties, or by a selected combination of these spring types.

Also contemplated as being within the scope of the invention, is the use of multiple tuned mass dampers and multiple axis particle dampers on a single structure. Since a structure may be subject to multiple vibration sources having different frequencies, locations and orientations, a typical configuration using dampers in accordance with the invention may require multiple dampers, each configured to damp vibrations from one or more separate sources. Thus it will be appreciated that although a specific embodiment of the invention has been illustrated and described, various modifications may be made without departing from the spirit and scope of the invention. Accordingly, the invention should not be limited except as by the appended claims.

1. Apparatus for attenuating vibration in a flexible structure, comprising:
a tuned mass damping element, coupled to the flexible structure and having parameters selected to attenuate vibration over a desired frequency range; and
a particle mass damping element, coupled to the tuned mass damping element and having parameters selected to attenuate vibration over a desired broad range of frequencies;
wherein the combined effect of the tuned mass damping element and the particle mass damping element is to increase the frequency range of vibration attenuation of the tuned mass damping element.

2. Apparatus as defined in claim 1, wherein:
the tuned mass damping element comprises a tuning beam; and
the particle mass damping element comprises a particle container affixed to the tuning beam, and a plurality of particles occupying the container up to a height that leaves a desired gap above the particles.

3. Apparatus as defined in claim 2, wherein the frequency response of the apparatus is affected by the following adjustable elements:
the length of the tuning rod;
the gap height above the particles in the container; and
the size and material of the particles.

4. Apparatus as defined in claim 3, wherein:
the adjustable elements are adjusted to provide a desired frequency response characterized a symmetrical arrangement of two peaks of approximately equal height, defining a relatively broad frequency band over which damping takes place.

5. Apparatus as defined in claim 4, wherein:
the particle container is cylindrical; and
the particles are uniformly sized spheres of a metal material.

6. Apparatus as defined in claim 5, where:
the particles are of a material selected from the group comprising lead, tungsten and steel.

7. A method for attenuating vibration in a flexible structure, comprising:
coupling a tuned mass to the flexible structure;
coupling a particle mass damper to the tuned mass; and, as a result of the combined effects of tuned mass damping and particle damping,
extending the range of frequencies over which vibration damping is provided by a tuned mass damping alone.

8. A method as defined in claim 7, and further comprising the step of selecting tuned mass damping parameters and particle mass damping parameters to achieve a desired overall damping response.

9. A method as defined in claim 8, wherein the step of selecting tuned mass damping parameters and particle mass damping parameters comprises:
selecting the length of a primary beam of the tuned mass damper;
selecting the length of a tuned beam used to couple the particle mass damper to the tuned mass;
selecting particle size and material; and
selecting a cylinder gap height, measured between the particles and an upper cylinder wall.
